(19) United States
(12) Patent Application Publication
(10) Pub. No.: US 2012/0305648 A1
(43) Pub. Date: Dec. 6, 2012

(54) Hybrid Mobile Phone/Pin Entry Device, System, Method and Article

(75) Inventors: Sanjay Sondhi, Isleworth (GB); Robert Todd Sullivan, St. Leonards-on-sea (GB)

(73) Assignee: LIQUID PAYMENT SOLUTIONS PTE LTD, Singapore (SG)

(21) Appl. No.: 13/486,812

(22) Filed: Jun. 1, 2012

Related U.S. Application Data
(60) Provisional application No. 61/520,037, filed on Jun. 3, 2011.

(51) Int. Cl. G06K 7/01; G06K 7/06

(52) U.S. Cl. 235/441; 235/439

(57) ABSTRACT

A hybrid terminal device includes a payment card reader and smart phone and is configured to facilitate financial transactions. The hybrid terminal device is configured to secure the payment card reader, such as from bugging devices, etc. The payment card reader may be secured by a portion of a body of the hybrid terminal device configured to block access to a card slot of the payment card reader when in a closed position. The payment card reader may be secured by a security screen enclosing all or part of the card reader, which includes tamper detection systems, such as traces and blind switches. The payment card reader includes a module configured to detect tamping with the card reader, for example by detecting shorting or breaking of traces or triggering of blind switches.

### BACKGROUND

1. Technical Field

The present disclosure relates to systems, methods and articles for securing payment acceptor devices, such as hybrid mobile phone/PIN entry devices.

2. Description of the Related-Art

Credit and debit card financial transactions may occur using a payment acceptor device coupled to a plain-old-telephone system (POTS). The card is read by the payment acceptor device, which contacts a financial institution through the POTS to obtain authorization for the transaction.

### BRIEF SUMMARY

In an embodiment, a hybrid terminal device comprises a smart phone module and a card reader module. In an embodiment, the hybrid terminal device further comprises a body having a first portion including the smart phone module and a second portion including the card reader module and movably coupled to the first portion between an open and a closed position of the device, wherein in a closed position access to a card slot of the card reader module is blocked. In an embodiment, access to the card slot of the card reader module is blocked when the device is partially closed. In an embodiment, the card reader module comprises a security screen secured to an inner surface of the second portion of body, forming a secure area enclosing a smart-card reading connector, a keypad flexprint, a printed circuit board assembly cover, a plurality of blind keys, a metal dome foil, a printed circuit board assembly (PCBA), and an LCD interface. In an embodiment, the security screen comprises a plurality of traces and the PCBA comprises one or more security modules configured to detect at least one of a shorting and a breaking of the traces of the security screen and to implement security measures in response to detection of the at least one of a shorting and a breaking. In an embodiment, one or more of the security modules are configured to detect triggering of one or more of the blind keys and to implement security measures in response to detecting the triggering. In an embodiment, the PCBA comprises multiple layers including a plurality of security layers, each of the security layers comprises a plurality of traces, and one or more of the security modules are configured to detect at least one of a shorting and a breaking of one or more of the traces of the security layers and to initiate security measures in response to the detection.

In an embodiment, a hybrid terminal device comprises: means for sending and receiving voice and data signals; means for reading credit/debit cards communicatively coupled to the means for sending and receiving voice and data signals; and means for securing the means for reading credit/debit cards.

In an embodiment, a method of manufacturing any of the devices disclosed herein may be employed.

In an embodiment, a hybrid terminal device comprises: a two-part body having a first portion and a second portion movable coupled to the first portion between an open and closed position; a smart phone module; and a card reader module, wherein in a closed position access to a card slot of the card reader module is blocked. In an embodiment, access to the card slot of the card reader is blocked when the device is partially closed. In an embodiment, at least part of the smart phone module is included in the first portion of the body and at least part of the card reader module is included in the second portion of the body. In an embodiment, the smart phone module and the card reader module are included in the second portion of the body. In an embodiment, in a closed position, there is insufficient room between the first portion and the second portion to attach a PIN disclosing bug or device or a key disclosing bug or device. In an embodiment, there is insufficient room in the body of the device to insert a PIN disclosing bug or device or a key disclosing bug or device. In an embodiment, the hybrid terminal device further comprises a security screen secured to an inner surface of the body of the device and configured to form a secure area enclosing at least part of the card reader module. In an embodiment, the enclosed at least part of the card reader module includes at least one of: a smart-card reading connector; a keypad flexprint; a printed circuit board assembly cover; a plurality of blind keys; a metal dome foil; a printed circuit board assembly (PCBA); and an LCD interface. In an embodiment, the security screen comprises a plurality of traces and encloses a printed circuit board assembly (PCBA) having one or more security modules configured to detect at least one of a shorting and a breaking of the traces of the security screen and to initiate one or more security measures in response to detection of the at least one of a shorting and a breaking of the traces of the security screen. In an embodiment, the security screen encloses one or more blind keys and the one or more of the security modules are configured to detect triggering of one or more of the blind keys and to initiate one or more security measures in response to detecting the triggering. In an embodiment, the PCBA comprises multiple layers including a plurality of security layers, each of the security layers comprises a plurality of traces, and one or more of the security modules are configured to detect at least one of a shorting and a breaking of one or more of the traces of the security layers and to initiate one or more security measures in response to the detection of the at least one of a shorting and a breaking of the one or more traces of the security layers.

In an embodiment, a hybrid terminal device comprises: means for sending and receiving voice and data signals; means for reading credit/debit cards communicatively coupled to the means for sending and receiving voice and data signals; and means for securing the means for reading credit/debit cards. In an embodiment, the hybrid terminal device comprises a body having a first portion and a second portion, wherein the means for reading credit/debit cards comprises a card reader module included in the second portion of the body, the second portion of the body is movably coupled to the first portion of the body between an open and a closed position of the device, and in a closed position access to a card slot of the card reader module is blocked. In an embodiment the means for securing the means for reading credit/debit cards comprises a security screen secured to an inner surface of a body of the device and configured to form a secure area enclosing at least part of the means for reading credit/debit cards. In an embodiment, the enclosed at least part of the means for reading credit/debit cards includes at least one of: a smart-card reading connector; a keypad flexprint; a printed circuit board assembly cover; a plurality of blind keys; a metal dome foil; a printed circuit board assembly (PCBA); and an LCD interface. In an embodiment, the security screen comprises a plurality of traces and encloses a printed circuit board assembly (PCBA) having circuitry configured to detect at least one of a shorting and a breaking of the traces of the security screen. In an embodiment, the security screen encloses one or more blind keys and the PCBA includes circuitry configured to detect triggering of one or more of the blind keys. In an embodiment, the PCBA comprises multiple layers including a plurality of security layers, each of the security layers comprises a plurality of traces, and the PCBA includes circuitry configured to detect at least one of a shorting and a breaking of one or more of the traces of the security layers.

In an embodiment, a hybrid terminal device comprises: a smart phone module; a card reader module; and a security screen secured to an inner surface of the body of the device and configured to form a secure area enclosing at least part of the card reader module. In an embodiment, the enclosed at least part of the card reader module includes: a smart-card reading connector; a keypad flexprint; a printed circuit board assembly cover; a plurality of blind keys; a metal dome foil; a printed circuit board assembly (PCBA); and an LCD interface. In an embodiment, the security screen comprises a plurality of traces and the PCBA is configured to detect shorting and breaking of traces of the security screen and to initiate at least one security measure in response to detecting shorting or breaking of a trace of the security screen. In an embodiment, the PCBA is configured to detect triggering of one or more of the blind keys and to initiate at least one security measure in response to detecting triggering of a blind key. In an embodiment, the PCBA comprises multiple layers including a plurality of security layers, each of the security layers comprises a plurality of traces, and the PCBA is configured to detect shorting and breaking of traces of the security layers and to initiate at least one security measure in response to the detecting shorting or breaking of a trace of a security layer.

In an embodiment, a non-transitory computer-readable medium stores instructions that when executed by a card reading device configure the card reading device to: detect tampering with the card reading device by detecting at least one of: a shorting of a trace of a security screen enclosing at least part of the card reading device; a breaking of a trace of the security screen; a shorting of a trace of a layer of a multilayer printed circuit board assembly (PCBA) enclosed by the security screen; a breaking of a trace of the layer of the PCBA; and a triggering of a blind switch enclosed by the security screen; and respond to a detection of tampering with the card reading device by initiating at least one security measure.

In an embodiment, responding to detection of tampering with the card reading device comprises providing an indication that the card reading device has been tampered with. In an embodiment, responding to detection of tampering with the card reading device comprises impairing functioning of the card reading device.

### BRIEF DESCRIPTION OF THE SEVERAL VIEWS OF THE DRAWING(S)

FIG. 1 shows an embodiment of a hybrid terminal device in a closed position from two perspectives.

FIG. 2 shows a perspective view of an embodiment of a hybrid terminal device in a partially open position.

FIG. 3 shows a perspective view of an embodiment of a hybrid terminal device in an open position.

FIG. 4 shows a perspective view of an embodiment of a hybrid terminal device in an open position.

FIG. 5 is a side view of an embodiment of a hybrid terminal device.

FIG. 6 is a top view of a portion of an embodiment of a hybrid terminal device.

FIG. 7 illustrates a mechanical assembly of an embodiment of a card reader module of a hybrid device.

FIG. 8 is a perspective view of an embodiment of a security screen.

FIG. 9 is a perspective view of an embodiment of a card reader module of a hybrid device.

FIG. 10 is a functional block diagram of an embodiment of a PCI compliant PED module.

FIG. 11 illustrates an embodiment of a security layer of a multi-layer printed circuit board.

FIG. 12 illustrates another embodiment of a security layer of a multi-layer printed circuit board.

FIG. 13 shows a perspective view of an embodiment of a hybrid terminal device in a closed position.

FIG. 14 shows a perspective view of an embodiment of a hybrid terminal device in a closed position.

FIG. 15 shows a perspective view of an embodiment of a hybrid terminal device in a closed position.

FIG. 16 shows a perspective view of an embodiment of a hybrid terminal device in a closed position.

FIG. 17 shows a perspective view of an embodiment of a hybrid terminal device in a closed position.

FIG. 18 shows a perspective view of an embodiment of a hybrid terminal device in a closed position.

FIG. 19 shows a perspective view of an embodiment of a hybrid terminal device in a closed position.

FIG. 21 shows a perspective view of an embodiment of a hybrid terminal device in an open position.

FIG. 22 shows a perspective view of an embodiment of a hybrid terminal device in an open position.

FIG. 23 shows a perspective view of an embodiment of a hybrid terminal device in an open position and in a closed position.

FIG. 24 shows a perspective view of an embodiment of a hybrid terminal device in an open position and in a closed position.

FIG. 25 shows a perspective view of an embodiment of a hybrid terminal device in an open position.

FIG. 26 shows a perspective view of an embodiment of a hybrid terminal device in an open position.

### DETAILED DESCRIPTION

In the following description, certain details are set forth in order to provide a thorough understanding of various embodiments of devices, systems, methods and articles. However, one of skill in the art will understand that other embodiments may be practiced without these details. In other instances, well-known structures and methods associated with, for example, mobile devices such as smart phones, card readers, point-of-sale systems, secure modules, computing systems, virtual computing systems, processors, telecommunication networks, web browsers, web servers, etc., have not been shown or described in detail in some figures to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is, as “including, but not limited to.”

Reference throughout this specification to “one embodiment,” or “an embodiment” means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure or the claimed invention.

The sizes and relative positions of elements in the drawings are not necessarily drawn to scale. For example, the shapes of various elements and angles are necessarily not drawn to scale, and some of these elements are enlarged and positioned to improve drawing legibility. Further, the particular shapes of the elements as drawn are not necessarily intended to convey any information regarding the actual shape of particular elements, and have been selected solely for ease of recognition in the drawings. In addition, the use of geometric terms and the illustrations are not intended to indicate that embodiments have ideal geometric shapes.

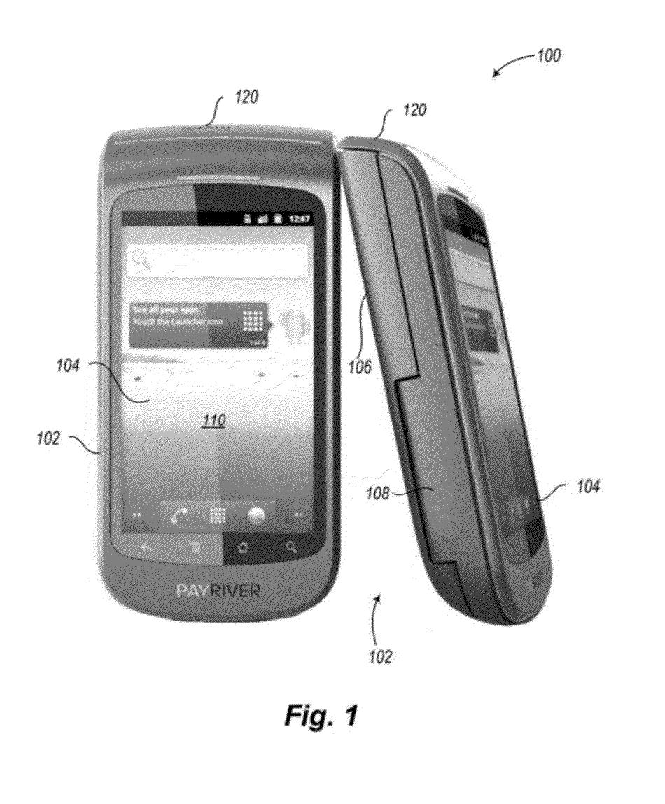

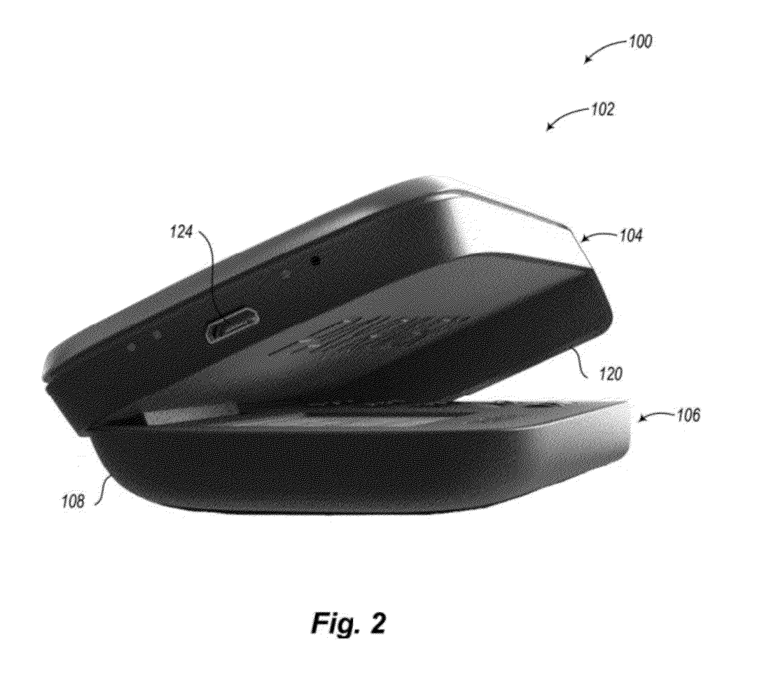

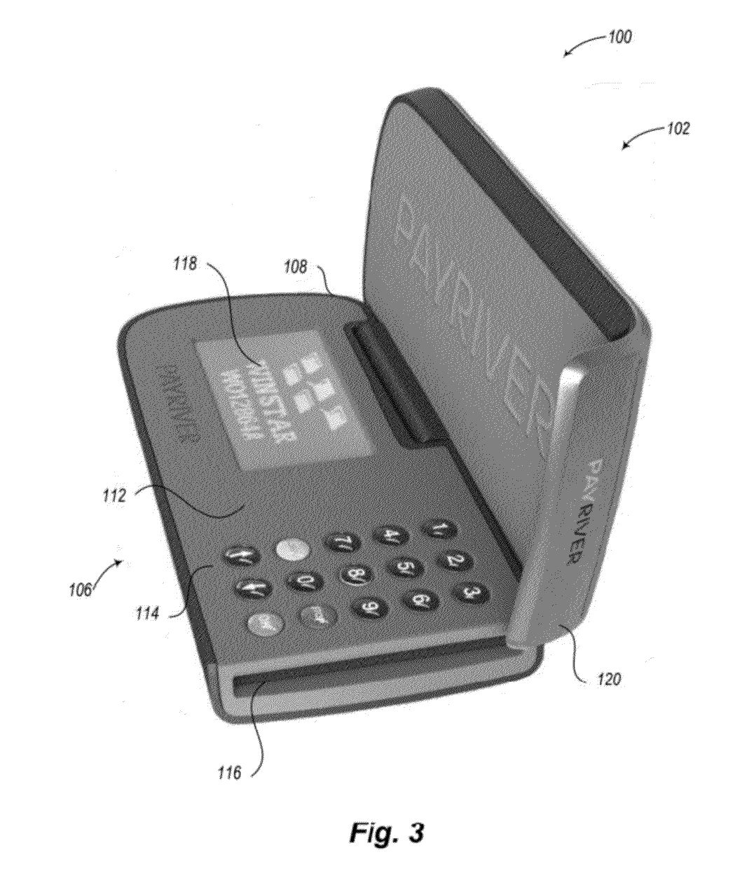

FIG. 1-4 show various perspective views of an embodiment of a hybrid terminal device (Smart Phone/Pin Entry Device (SP/PED)) 100 that includes smart phone and electronic point-of-sale functionality. As illustrated, the hybrid terminal device SP/PED 100 is part smart phone and part Smart Card Reader/Pin Entry Device. As discussed in more detail herein, embodiments of the hybrid terminal device SP/PED 100 may be configured to communicatively couple to one or more remote servers to facilitate face-to-face financial transactions, and to couple to one or more communication networks to facilitate voice and data communications. As illustrated, the hybrid terminal device 100 bears the mark PAYRIVER™, which is a mark used in connection with financial transaction-related goods and services, and which is owned by Liquid Payment Solutions Pte Ltd.

As illustrated, the hybrid terminal device 100 comprises a two-part body 102 with a first portion 104 and a second portion 106 moveably coupled together. As illustrated, a hinge 108 is employed to moveably couple the two-part body 102 together. In an embodiment, once the portions 104, 106 of the hybrid device 100 are assembled together, there is no external access to screws, etc., to facilitate disassembly of the hybrid device. Other mechanical coupling systems may be employed.

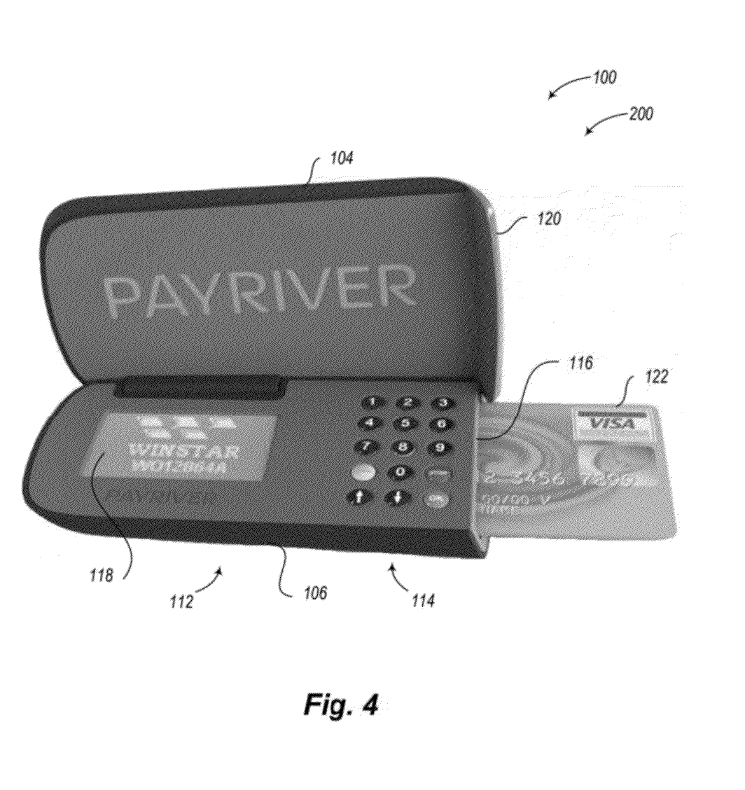

As illustrated, the first portion 104 of the two-part body 102 comprises a smart phone (SP) user interface 110 and the second portion 106 comprises a smart card reader/pin entry device (PED) 112. In another example, one portion may comprise a card reader and another portion may comprise a computing and telecommunications system. In an embodiment, modules providing functionality may be distributed between the first and second portions 104, 106 of the hybrid device 100. For example, a smart phone user interface 110 for a smart phone of the hybrid device 100 may include a battery which also supplies power to a PED in the second portion 106 of the hybrid device 100. As illustrated, the first portion 104 of the hybrid device 100 comprises an interface 124, such as a USB micro port, headphone port, power port, etc. Various combinations of multiple interfaces may be employed. The card reader 112 comprises a 15 key keypad 114, a card slot 116, and an LCD display 118. As illustrated, the LCD display 118 comprises a WINSTAR WO12864A. Other displays may be employed. Other modules providing functionality for an embodiment of the card reader 112 are discussed below. The first portion 104 of the body 102 comprises an extended portion or flap 120 positioned to, when the hybrid device 100 is in a closed position or partially closed position, prevent access to the card slot 116. When the hybrid device 100 is in the open position (see FIG. 4), the flap 120 is positioned to allow access to the card slot 116, facilitating insertion of a card 122 into the slot 116 of the card reader 112.

The card reader 112 may comprise user interfaces, such as, for example, a PC/SC EMV L1/L2 certified Smart Card Reader, a keypad for PIN entry, such as the illustrated 15 key keypad 114, a display, such as the illustrated 4×16 alpha-numeric LCD display, etc., and electrical interfaces such as, for example, an RS232 Host (phone) connection (for example, with a 4.2 Vdc power), a TTL Host (phone) interface (such as with a similar protocol to RS232 running at CMOS voltages), an interface for back-up battery power, an interface for a display, a power interface, etc. The card reader 112 may comprise PCI PED compliant devices, such as an Innovacard USIP-Pro Controller available from Maxim of Sunnydale, Calif., etc. The card reader may be, for example, PCI v3 compliant. The smart phone module may be, for example, an Android smart phone with an interface to the PED module configured to facilitate the acceptance of credit/debit card payments.

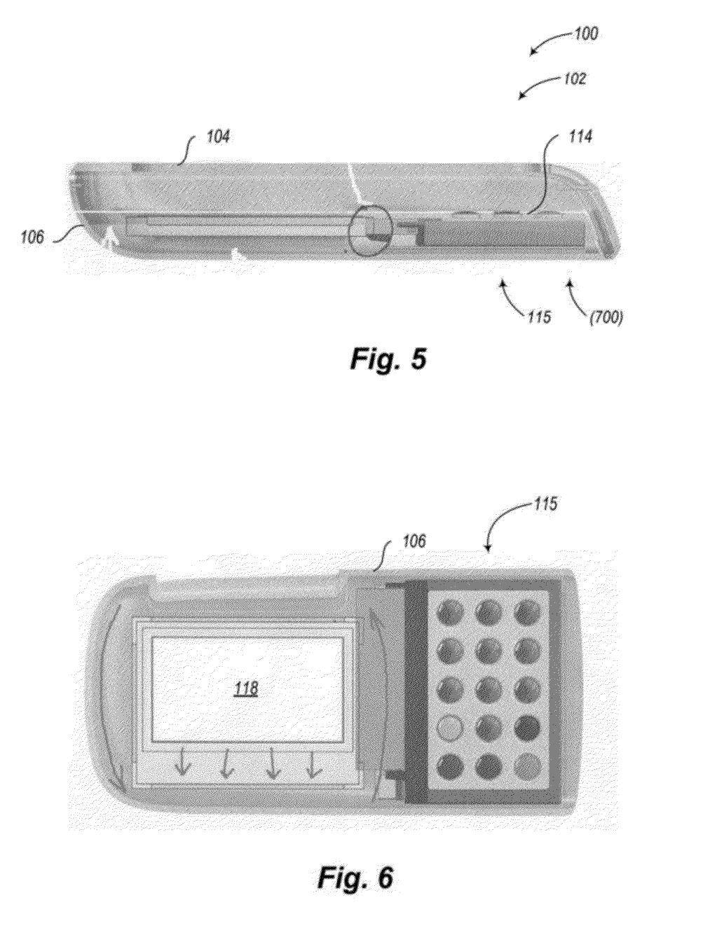

FIG. 5 is a partially transparent enlarged side view of an embodiment of a hybrid SP/PED device 100 in a closed position. FIG. 6 is a partially transparent enlarged top view of the second portion 106 of an embodiment of a hybrid SP/PED 100. The second portion 106 forms a skin around the keypad enclosure 115 of the keypad 114, the LCD 118, and a battery area 126. As illustrated, there is no room in the second portion to insert a PIN disclosing bug or device or a key disclosing bug or device. In addition, there is no room to close the hybrid device 100 if an attempt is made to adhere such a bug to the second portion 106 of the hybrid SP/PED 100. As discussed in more detail below, in an embodiment a security module has tamper responsive protection.

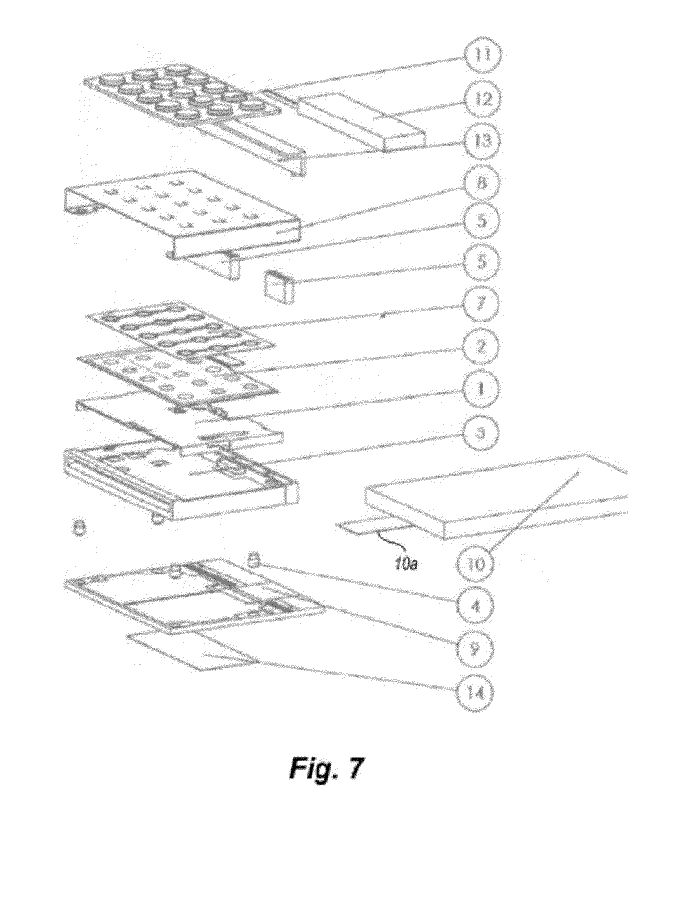

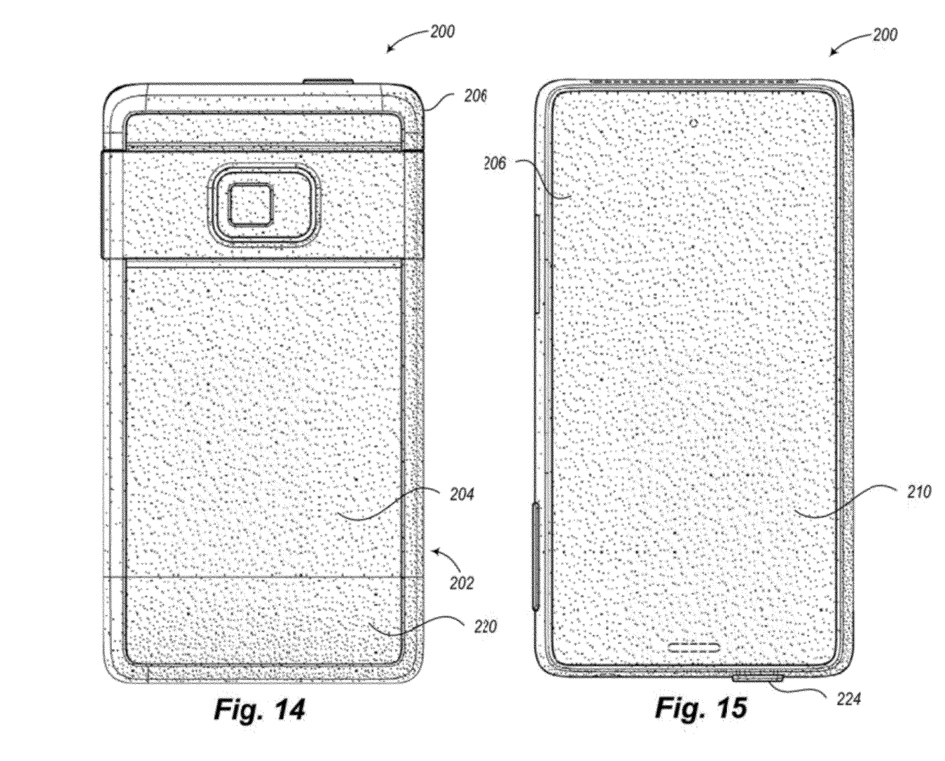

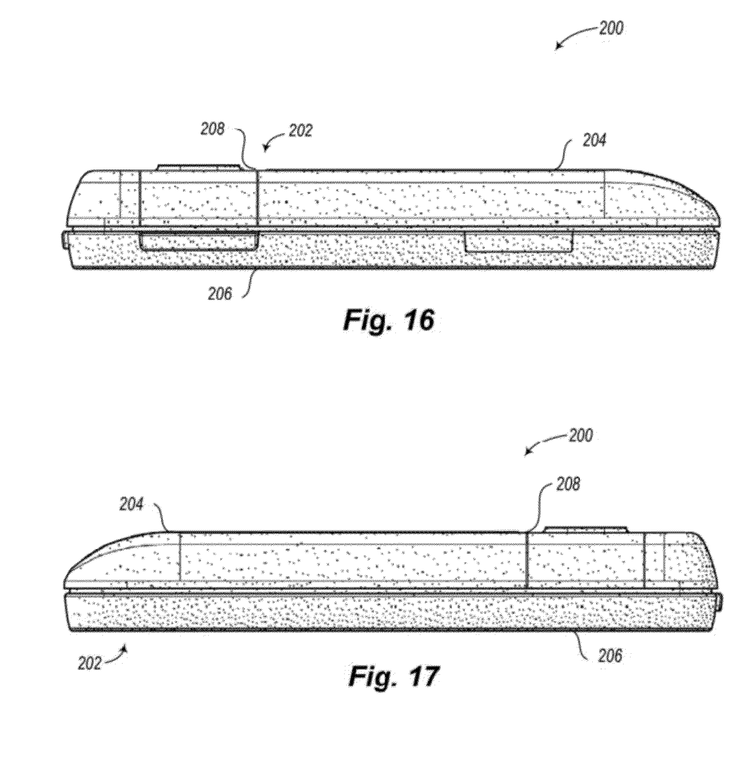

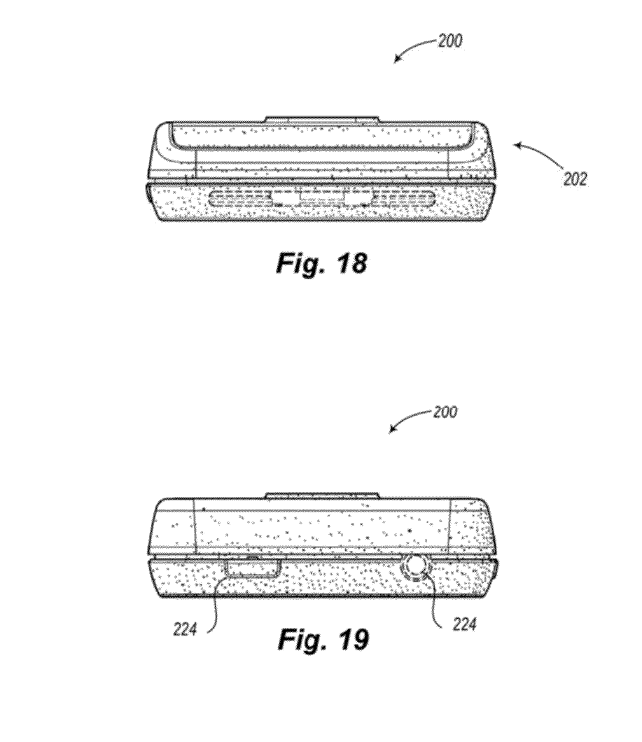

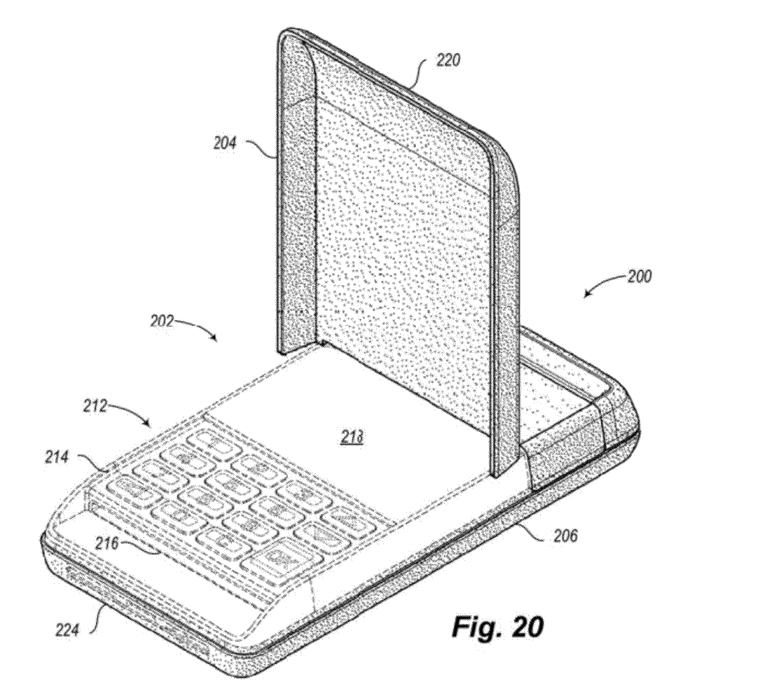

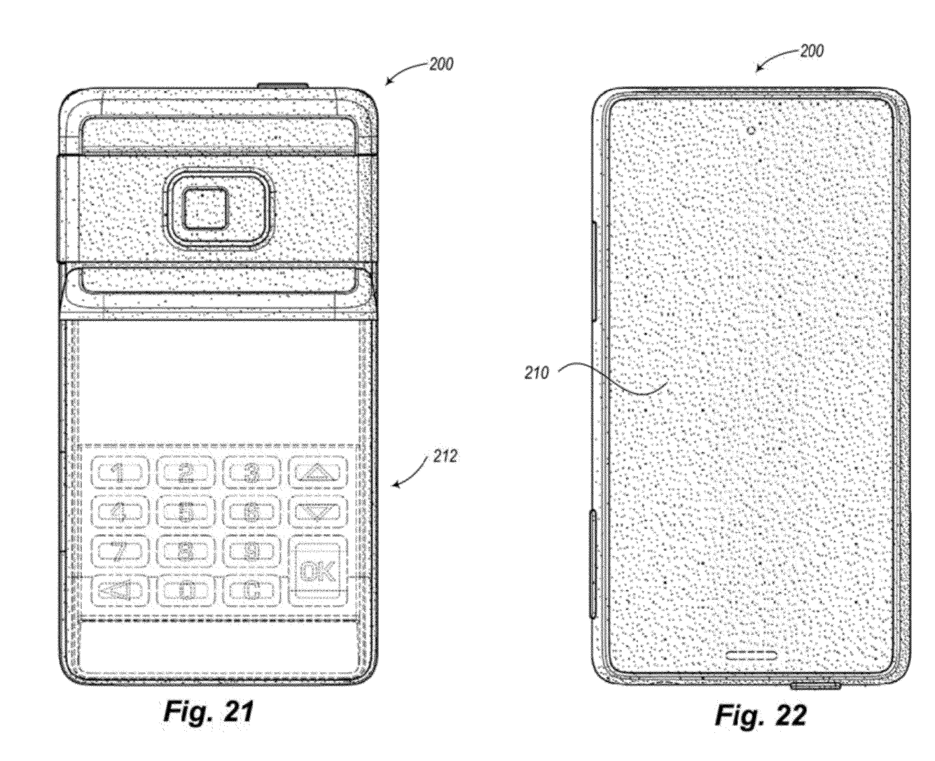

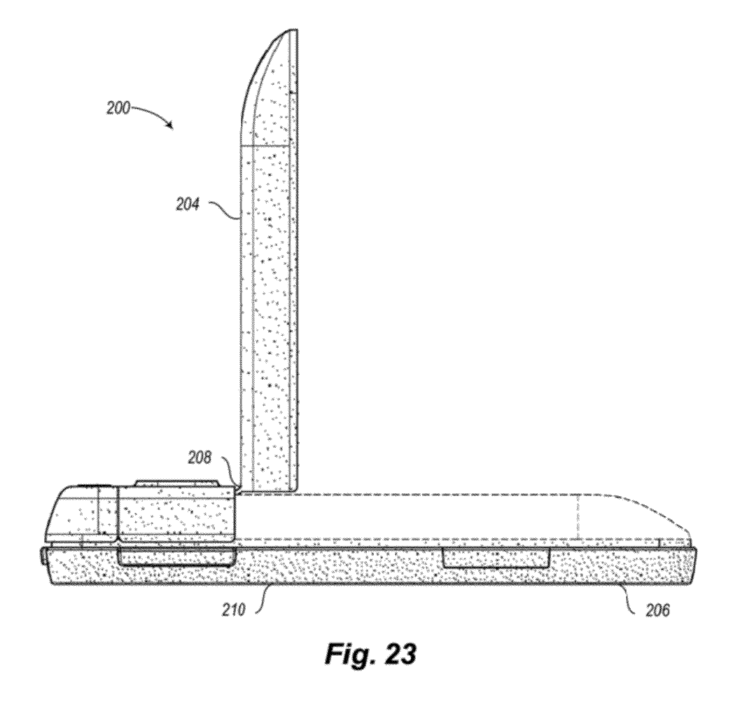

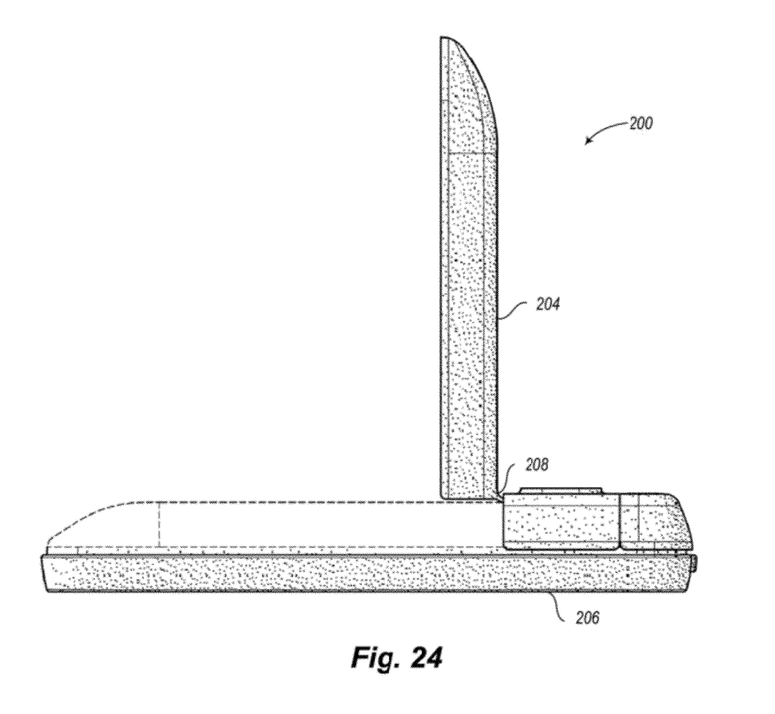

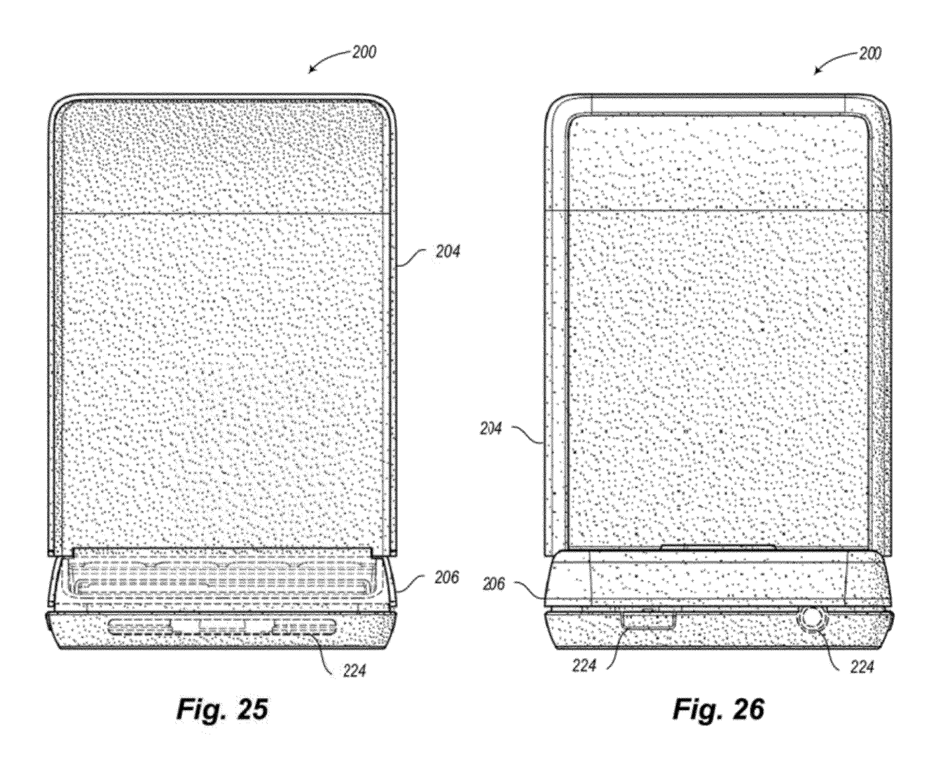

FIG. 7 illustrates a mechanical assembly of an embodiment of a PCI PED assembly 700, suitable for use, for example, in the embodiments of FIGS. 1-5 and 13-26 (see for example, FIG. 5). The assembly comprises a smart-card reading connector 1 (which may be a standard part), a keypad flexprint 2, a printed circuit board assembly cover 3 (which may be a custom part), a plurality of blind keys 4, a plurality of connectors 5, a metal dome foil 7, a security screen 8, a printed circuit board assembly 9, an LCD module 10, a rubber keypad 11, a backup battery 12, a bracket 13 configured to secure the connectors 5, and a printed product label assembly 14. As discussed in more detail below, the security screen may be configured to form a secure area and electronic and mechanical monitoring and sensing methods may be employed to detect tampering, including tampering occurring when the device 100 is powered and tampering when the device is not powered. The smart card reading connector 1 is fully enclosed in the secure area (as are other components as discussed below), which provides additional protection because the chip card contacts are deep in the module. In addition, the card entry slot remains fully visible to the operator when the device is in use.

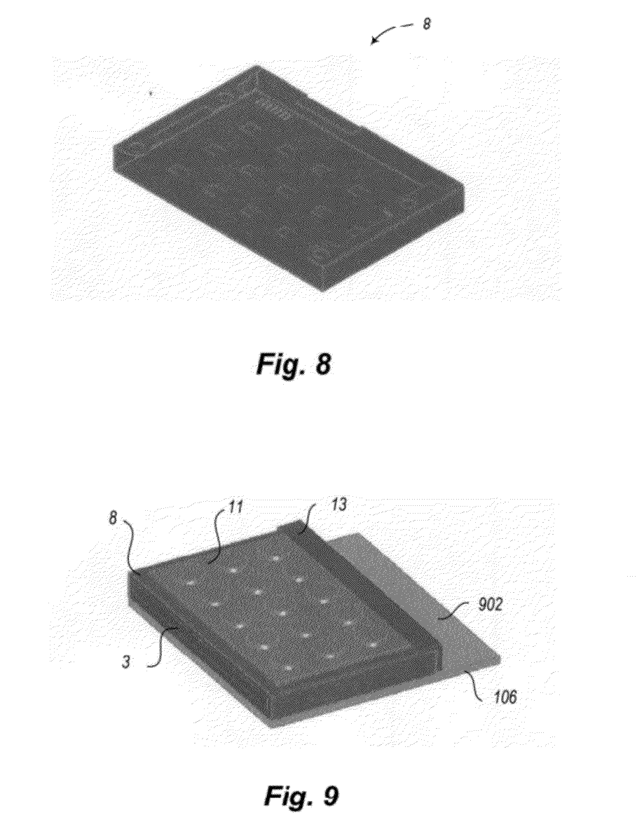

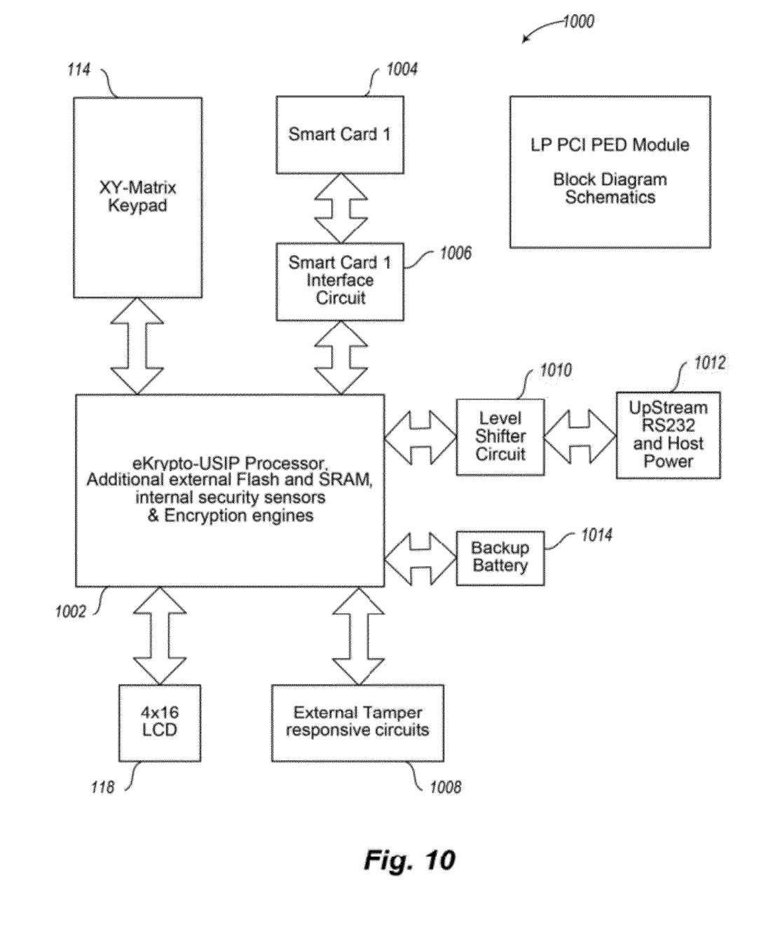

FIG. 8 illustrates an embodiment of a folded security screen 8 formed from a sheet of suitable material. For example, the security screen may be fabricated using copper film that is chemically etched or printed and laminated between layers of polyester insulation. FIG. 9 illustrates a portion of the assembly 700 of FIG. 7 as assembled and glued into the second portion 106 of an embodiment of a hybrid device 100. The foldable security screen 8 comprises a plurality of conductive traces or tracks on both sides, for example, copper traces, etc. The conductive traces may be, for example, spaced 0.125 mm or less apart, and may have a thickness of, for example, 0.125 mm or less, and may criss-cross on both sides of the sheet. As illustrated in FIG. 9, the security screen 8 may be glued (for example, using a high-temperature resistant glue) to an inner surface 902 of the second portion 106 of the body 102, and mechanically secured by other components of the assembly, forming a secure area fully enclosing the smart-card reading connector 1, the keypad flexprint 2, the printed circuit board assembly cover 3, the plurality of blind keys 4, the metal dome foil 7, and the printed circuit board assembly (PCBA) 9, as well as an LCD interface connector 10a for the LCD 10. The security screen 8 is configured such that removal of the security screen 8 is detectable by tamper resistant mechanisms of the device 100 (see processor 1002 and external tamper response circuits 1008 of FIG. 10). In some embodiments, the screen 8 may be glued to another component of the assembly, such as the PCBA cover 3. The smart card reading connector 1 is fully enclosed in the secure area. In an embodiment, the blind keys 4 are configured to remain closed when the secure PCI PED assembly remains secure (for example, as long as the assembly has not been tampered with). If the assembly is tampered with, the blind keys are configured to trigger. The blind keys may be configured to remain open once triggered. A plurality of blind keys may be employed to increase the likelihood that any attempt to remove the PCBA from the assembly will be detected. In an embodiment, non-accessible low-travel bind keys may be employed and configured to simulate a broken track, which can be detected by an security sensor of the device 100 (see processor 1002 and external tamper response circuits 1008 of FIG. 10).

FIG. 10 is a functional block diagram of an embodiment of PCI PED module 1000, suitable for use, for example, in the embodiments of FIGS. 1-7, 9 and 13-26. The module 1000 comprises a processor 1002, as illustrated an eKrypto USIP processor from eKrypto. Other processors may be employed, such as an InnovaCard USIP-PRO, etc. The processor 1002 includes internal memory, internal security sensors configured to detect, for example, tampering with the module, and encryption/decryption engines. The module 1000 may also comprise additional external flash and SRAM. The module also comprises a keypad 114 configured to receive user input, such as PIN entries, a smart card 1004, a smart card interface circuit 1006 configured to control communications between the smart card 1004 and the processor 1002, a LCD display 118, external tamper responsive circuits 1008 configured to detect tampering with the module, for example, a break in a security track or triggering of a blind key, a level shifter circuit 1010, an upstream RS232 or TTL and host power block 1012 configured to couple to a host system, such as through a smart phone module of the hybrid device 100 (see FIG. 1), etc., and a backup battery 1014. The various components of the PCI PED module are communicatively coupled together, for example as illustrated by multiple bus systems. The internal sensors of the processor and the external tamper response circuits are configured to implement tamper response mechanisms in response to detection of tampering with the device. For example, in response to an attack a sensor or response mechanism may reset the hybrid device, reset the PCI PED module, partially or completely disable the hybrid device or the PCI PED module, generate and/or transmit error messages, etc. In an embodiment, the PCI PED module may be based on a system-on-a-chip (SOC) design, which may reduce the overall size and power consumption of the device.

A six layer PCBA (see PCBA 9 of FIG. 7) is employed in an embodiment. The PCBA may contain all the secure electronics and user interface connectors. In an embodiment, no sensitive data is transmitted in clear over the connector lines. In an embodiment, when connecting to the outside world, no secret information of critical components is able to be accessed through the external interface. Only publicly known information or encrypted data may be passed to increase attack difficulty.

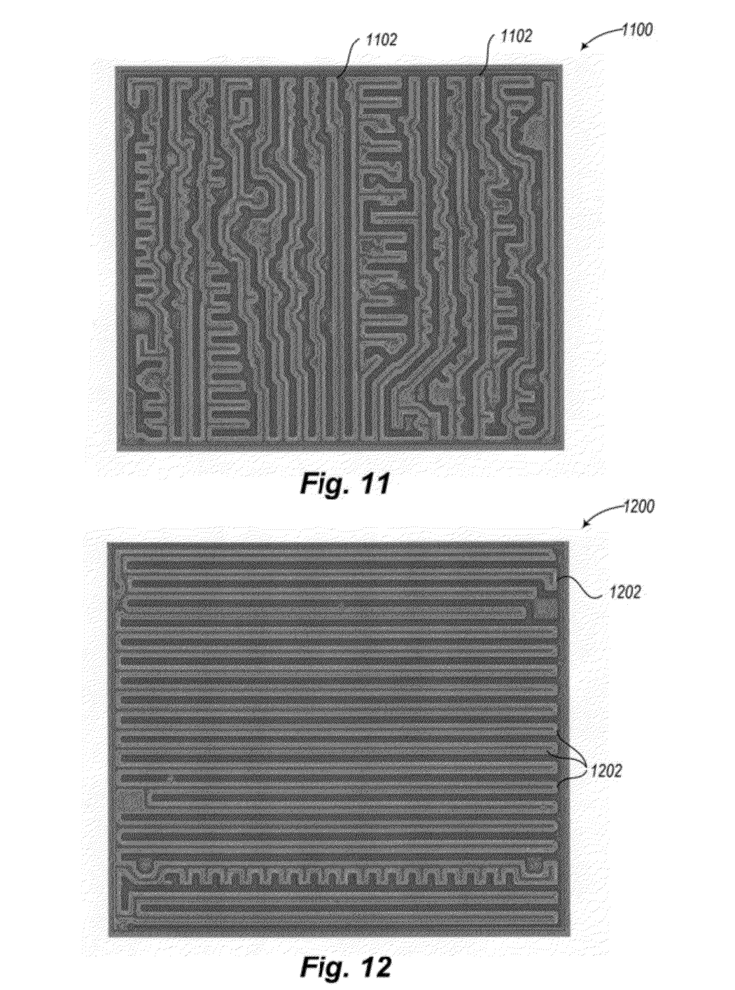

In an embodiment, a bundle of traces crisscrosses on a plurality of layers of the PCBA 9. FIG. 11 illustrates traces of a first layer 1100 having a plurality of traces 1102 and FIG. 12 illustrates a second layer 1200 having a plurality of traces 1202. In an embodiment, the traces comprise copper traces having a spacing of 0.125 mm or less and a thickness of 0.125 mm or less. The traces are electrically coupled to the processor and/or to tamper response circuits, which are configured to implement tamper response mechanism in response to shorting or breaking of one or more of the traces. For example, an electrical state of a sensor internal to the processor 1002 or external to the processor 1002 may change in response to breaking or shorting of a trace. Other patterns for the traces 1102, 1202 may be employed. One or more traces may be coupled together in some embodiments. The electrical couplings of the traces 1102, 1202 to the sensors and/or to each other may comprise capacitive elements, resistive elements, inductive elements, etc., in some embodiments.

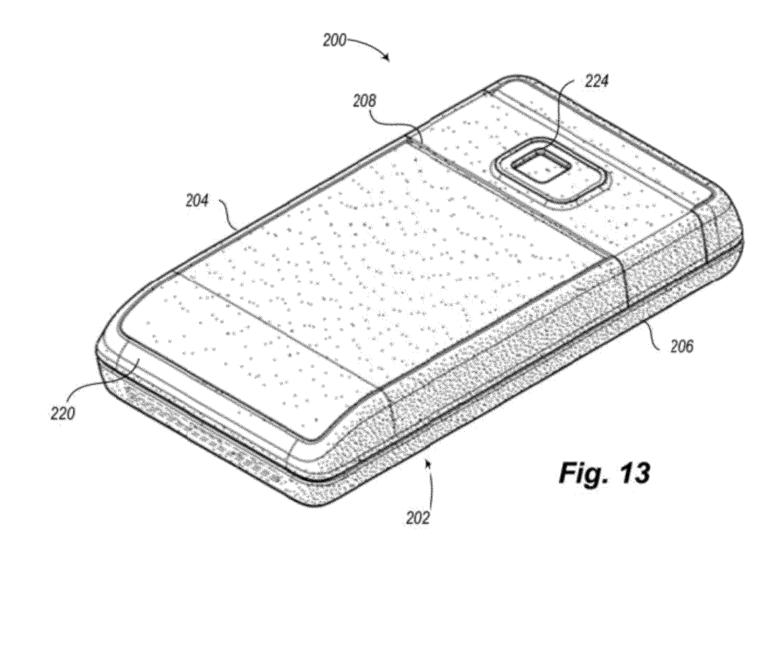

FIGS. 13-26 show various perspective views of an embodiment of a hybrid terminal device (Smart Phone/Pin Entry Device (SP/PED)) 200 that includes smart phone and electronic point-of-sale functionality. As illustrated, the hybrid terminal device SP/PED 200 is part smart phone and part Smart Card Reader/Pin Entry Device. As discussed in more detail herein, embodiments of the hybrid terminal device SP/PED 200 may be configured to communicatively couple to one or more remote servers to facilitate face-to-face financial transactions, and to couple to one or more communication networks to facilitate voice and data communications.

As illustrated, the hybrid terminal device 200 comprises a two-part body 202 with a first portion 204 and a second portion 206 moveably coupled together. As illustrated, a hinge 208 is employed to moveably couple the two-part body 202 together. In an embodiment, once the portions 204, 206 of the hybrid device 200 are assembled together, there is no external access to screws, etc., to facilitate disassembly of the hybrid device. Other mechanical coupling systems may be employed.

As illustrated, the first portion 204 of the two-part body 202 comprises a smart phone (SP) user interface 210 (such as a smart phone touch screen, etc.) and a smart card reader/pin entry device (PED) 212. In another example embodiment, one portion may comprise a card reader and another portion may comprise a computing and telecommunications system. The second portion 206 of the two-part body 202 comprises a cover to secure the PED 212 when not in use. In an embodiment, modules providing functionality may be distributed between the first and second portions 204, 206 of the hybrid device 200. As illustrated, the first portion 204 of the hybrid device 200 comprises one or more interfaces 224, such as a USB micro port, headphone port, power port, memory card slot, camera, switches, etc. Various combinations of multiple interfaces may be employed.

The card reader 212 comprises a 15 key keypad 214, a card slot 216, and an LCD display 218. Other displays may be employed. Other modules providing functionality for an embodiment of the card reader 212 are discussed elsewhere herein.

The first portion 204 of the body 202 comprises an extended portion or flap 220 positioned to, when the hybrid device 200 is in a closed position or partially closed position in some embodiment, prevent access to the card slot 216. When the hybrid device 200 is in the open position (see FIG. 20), the flap 220 is positioned to allow access to the card slot 216, facilitating insertion of a card (see card 122 of FIG. 4) into the slot 216 of the card reader 212.

The card reader 212 may comprise user interfaces, such as, for example, a PC/SC EMV L1/L2 certified Smart Card Reader, a keypad for PIN entry, such as the illustrated 15 key keypad 214, a display, such as the illustrated LCD display, etc., and electrical interfaces such as, for example, an RS232 Host (phone) connection (for example, with a 4.2 Vdc power), a TTL Host (phone) interface (such as with a similar protocol to RS232 running at CMOS voltages), an interface for back-up battery power, an interface for a display, a power interface, etc. The card reader 212 may comprise PCI PED compliant devices, such as an Innovacard USIP-Pro Controller available from Maxim of Sunnydale, Calif., etc. The card reader may be, for example, PCI v3 compliant. The smart phone module may be, for example, an Android smart phone with an interface to the PED module configured to facilitate the acceptance of credit/debit card payments.

Some embodiments may take the form of or comprise computer program products. For example, according to one embodiment there is provided a computer readable medium comprising a computer program adapted to perform one or more of the methods or functions described above, such as detecting a shorting of a trace or a triggering of a blind key and initiating one or more responses to the detection. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof. For example, embodiments of a hybrid smart phone/point-of-sale terminal may be implemented as discussed above (e.g., partially in hardware, partially with controllers executing instructions, etc.).

Some embodiments of the hybrid devices described herein may include features or functionality disclosed in PCT Application No. PCT/US2011/068107 and/or PCT Application No. PCT/US2012/029082, which are incorporated herein by reference in their entireties.

The various embodiments described above and in the various patents, applications and publications can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A hybrid terminal device, comprising:
a two-part body having a first portion and a second portion movable coupled to the first portion between an open and closed position;
a smart phone module; and
a card reader module, wherein in a closed position access to a card slot of the card reader module is blocked.

2. The hybrid terminal device of claim 1 wherein access to the card slot of the card reader is blocked when the device is partially closed.

3. The hybrid terminal device of claim 1 wherein at least part of the smart phone module is included in the first portion of the body and at least part of the card reader module is included in the second portion of the body.

4. The hybrid terminal device of claim 1 wherein the smart phone module and the card reader module are included in the second portion of the body.

5. The hybrid terminal device of claim 1 wherein in a closed position, there is insufficient room between the first portion and the second portion to attach a PIN disclosing bug or device or a key disclosing bug or device.

6. The hybrid terminal device of claim 1 wherein there is insufficient room in the body of the device to insert a PIN disclosing bug or device or a key disclosing bug or device.

7. The hybrid terminal device of claim 1, further comprising a security screen secured to an inner surface of the body of the device and configured to form a secure area enclosing at least part of the card reader module.

8. The hybrid terminal device of claim 7 wherein the enclosed at least part of the card reader module includes at least one of:
a smart-card reading connector;
a keypad flexprint;
a printed circuit board assembly cover;
a plurality of blind keys;
a metal dome foil;
a printed circuit board assembly (PCBA); and
an LCD interface.

9. The hybrid terminal device of claim 8 wherein the security screen comprises a plurality of traces and encloses a printed circuit board assembly (PCBA) having one or more security modules configured to detect at least one of a shorting and a breaking of the traces of the security screen and to initiate one or more security measures in response to detection of the at least one of a shorting and a breaking of the traces of the security screen.

10. The hybrid terminal device of claim 9 wherein the security screen encloses one or more blind keys and the one or more of the security modules are configured to detect triggering of one or more of the blind keys and to initiate one or more security measures in response to detecting the triggering.

11. The hybrid terminal of claim 9 wherein the PCBA comprises multiple layers including a plurality of security layers, each of the security layers comprises a plurality of traces, and one or more of the security modules are configured to detect at least one of a shorting and a breaking of one or more of the traces of the security layers and to initiate one or more security measures in response to the detection of the at least one of a shorting and a breaking of the one or more traces of the security layers.

12. A hybrid terminal device, comprising:
means for sending and receiving voice and data signals;
means for reading credit/debit cards communicatively coupled to the means for sending and receiving voice and data signals; and
means for securing the means for reading credit/debit cards.

13. The hybrid terminal device of claim 12, comprising a body having a first portion and a second portion, wherein the means for reading credit/debit cards comprises a card reader module included in the second portion of the body, the second portion of the body is movably coupled to the first portion of the body between an open and a closed position of the device, and in a closed position access to a card slot of the card reader module is blocked.

14. The hybrid terminal device of claim 12 wherein the means for securing the means for reading credit/debit cards comprises a security screen secured to an inner surface of a body of the device and configured to form a secure area enclosing at least part of the means for reading credit/debit cards.

15. The hybrid terminal device of claim 14 wherein the enclosed at least part of the means for reading credit/debit cards includes at least one of:
a smart-card reading connector;
a keypad flexprint;
a printed circuit board assembly cover;
a plurality of blind keys;
a metal dome foil;
a printed circuit board assembly (PCBA); and
an LCD interface.

16. The hybrid terminal device of claim 14 wherein the security screen comprises a plurality of traces and encloses a printed circuit board assembly (PCBA) having circuitry configured to detect at least one of a shorting and a breaking of the traces of the security screen.

17. The hybrid terminal device of claim 16 wherein the security screen encloses one or more blind keys and the PCBA includes circuitry configured to detect triggering of one or more of the blind keys.

18. The hybrid terminal of claim 16 wherein the PCBA comprises multiple layers including a plurality of security layers, each of the security layers comprises a plurality of traces, and the PCBA includes circuitry configured to detect at least one of a shorting and a breaking of one or more of the traces of the security layers.

19. A hybrid terminal device, comprising:
a smart phone module;
a card reader module; and
a security screen secured to an inner surface of the body of the device and configured to form a secure area enclosing at least part of the card reader module.

20. The hybrid terminal device of claim 19 wherein the enclosed at least part of the card reader module includes:
a smart-card reading connector;
a keypad flexprint;
a printed circuit board assembly cover;
a plurality of blind keys;
a metal dome foil;
a printed circuit board assembly (PCBA); and
an LCD interface.

21. The hybrid terminal device of claim 20 wherein the security screen comprises a plurality of traces and the PCBA is configured to detect shorting and breaking of traces of the security screen and to initiate at least one security measure in response to detecting shorting or breaking of a trace of the security screen.

22. The hybrid terminal device of claim 20 wherein the PCBA is configured to detect triggering of one or more of the blind keys and to initiate at least one security measure in response to detecting triggering of a blind key.

23. The hybrid terminal of claim 20 wherein the PCBA comprises multiple layers including a plurality of security layers, each of the security layers comprises a plurality of traces, and the PCBA is configured to detect shorting and breaking of traces of the security layers and to initiate at least one security measure in response to the detecting shorting or breaking of a trace of a security layer.

24. A non-transitory computer-readable medium storing instructions that when executed by a card reading device configure the card reading device to:
detect tampering with the card reading device by detecting at least one of:
a shorting of a trace of a security screen enclosing at least part of the card reading device;
a breaking of a trace of the security screen;
a shorting of a trace of a layer of a multilayer printed circuit board assembly (PCBA) enclosed by the security screen;
a breaking of a trace of the layer of the PCBA; and
a triggering of a blind switch enclosed by the security screen; and
respond to a detection of tampering with the card reading device by initiating at least one security measure.

25. The non-transitory computer-readable medium of claim 24 wherein responding to detection of tampering with the card reading device comprises providing an indication that the card reading device has been tampered with.

26. The non-transitory computer-readable medium of claim 24 wherein the responding to detection of tampering with the card reading device comprises impairing functioning of the card reading device.
